(19) United States
(12) Patent Application Publication
(10) Pub. No.: US 2012/0206927 A1
(43) Pub. Date: Aug. 16, 2012

(54) LARGE LED LIGHTING APPARATUS

(75) Inventor: Takakazu Miyahara, Minamisatsuma-shi (JP)

(73) Assignee: ELM INC., Minamisatsuma-shi, Kagoshima (JP)

(21) Appl. No.: 13/503,251

(22) PCT Filed: Oct. 26, 2010
(86) PCT No.: PCT/JP2010/068994

§ 371 Date: Apr. 20, 2012

(30) Foreign Application Priority Data
Nov. 5, 2009 (JP) 2009-254398

(51) Int. Cl. F21V 29/00; F21V 21/00

(52) U.S. Cl. 362/382

(57) ABSTRACT

An LED lighting apparatus includes an LED-mounting base having LED elements mounted on its surface and a heat-dissipating section fixed on the back side of the LED-mounting base. The heat dissipating section is provided with: a core having a sealed space and heat-dissipating fins provided around the core. Thus, an LED lighting apparatus which has a shape substantially the same as that of a large mercury lighting apparatus, and which can efficiently dissipate heat generated from the LED elements, with only the smallest increase in the weight of the apparatus, can be provided. The electronic-circuit housing section may contain an electric circuit for generating power to be supplied to the LED elements. Furthermore, it is desirable to leave a small space in the electronic-circuit housing section so as to absorb the expansion of the cooling liquid, rather than completely fill the electronic-circuit housing section with the cooling liquid.

### TECHNICAL FIELD

The present invention relates to LED (light-emitting diode) bulbs, which have been rapidly spreading in recent years as an alternative to filament bulbs or mercury lamps which are less energy-efficient.

### BACKGROUND ART

In the cases of filament bulbs and tungsten halogen bulbs, which are the two types of conventional lighting apparatuses having low energy-efficiency, various kinds of LED bulbs have already been produced and marketed as practical alternatives. However, in the case of mercury lamps, which are a high-power device producing a large amount of light and are often used in a factory, large-scale retail store, warehouse, gymnasium or similar facility by being suspended from the ceiling or embedded in the ceiling or wall, no LED lighting apparatus that can totally replace them has been developed. This is due to the difficulty of dissipating a large amount of heat generated by LEDs. Conventionally marketed LED lighting apparatuses with a shape equivalent to commonly used mercury lighting apparatuses have a low power of 200 watts or less.

The efficiency of mercury lamps is inherently low; it is 50 lumens per watt, and yet they require several minutes to reach practical illumination levels. Furthermore, once turned off, they need a considerable length of time to be ready for the next activation. This means that mercury lamps cannot be frequently turned on and off, and therefore, are unfavorable for energy saving. Accordingly, there is a market demand for a large-sized, high energy-saving LED lighting apparatus that can replace mercury lamps.

Patent Document 1 discloses an LED lighting apparatus having a heat sink attached to an LED lamp. In this LED lighting apparatus, a fan is used to air-cool the heat sink.

### BACKGROUND ART DOCUMENT

### Patent Document

Patent Document 1: JP-A 2005-158746

### SUMMARY OF THE INVENTION

### Problem to be Solved by the Invention

The efficiency of LED elements that are easily obtainable nowadays is approximately 80 lumens per watt. A calculation using this value shows that, for an LED lighting apparatus to achieve an average illumination level of existing mercury lamps, i.e. 20,000 lumens, it is necessary to inject approximately 250 watts of power into the LEDs. The actually required amount of power is 200 watts or less because, as compared to a mercury lamp which radiates light in all directions, an LED element radiates light only within a hemisphere and accordingly has a higher level of illumination efficiency.

However, when 200-watt power is injected in LEDs, roughly 70% of the energy turns into heat, causing a 140-watt heat generation. Although LED elements are generally said to have a long service life, they are weak against heat. Depending on the production method, material type and other factors, an LED element is expected to have a life of 40,000 hours or longer if its temperature is maintained at approximately 100 degrees Celsius during its operation. However, its life is said to be approximately halved for every 10-degree increase in the temperature. Accordingly, the life of the LED lighting apparatus depends on how much the temperature of the LED element can be lowered by efficiently dissipating the aforementioned amount of heat equivalent to a 140-watt heater.

Cooling an object is easy if its heat-generating area is large. However, for an LED lighting apparatus to replace a mercury lamp, its light-emitting element must be roughly comparable in size to that of the mercury lamp, which means that the 140-watt heat generation occurs on an area of approximately 10 cm in diameter.

Consider the case where this amount of heat is conducted to a heat-dissipating mechanism through an aluminum-made conductor of the same diameter (10 cm) having a heat resistance of 236 W/m·K. If this conductor has a length of 10 cm, a temperature difference of 7.5 degrees occurs between its ends. However, a heat conductor made of pure aluminum with a diameter of 10 cm and a length of 10 cm weighs 2 kg or more, which is impractical from the viewpoints of weight and cost. Decreasing the diameter to 5 cm will reduce the weight to approximately 0.5 kg, a practically acceptable level as far as weight and cost are concerned. However, the temperature difference will increase to 30 degrees, which shortens the life of the LED element to one eighth.

Using a fan air-cooling system, as in Patent Document 1, decreases the energy efficiency since additional power is required for the fan. Furthermore, it increases the size of the lighting apparatus since additional space and equipment are required for the fan and a motor for the fan. Unfavorable factors concerning the durability also increase, such as a decrease in the heat-dissipating capacity or a failure of the fan motor due to suctioning of foreign matters (e.g. dust, spider webs and so on)

The problem to be solved by the present invention is to provide an LED lighting apparatus which has a shape substantially the same as that of large-sized mercury lighting apparatuses widely used in the world and can replace them, and which can efficiently dissipate heat generated from the LED element, with only the smallest increase in its weight.

### Means for Solving the Problems

An LED lighting apparatus according to the present invention aimed at solving the aforementioned problem is an LED lighting apparatus including an LED-mounting base having an LED element mounted on a surface thereof and a heat-dissipating section, where the heat-dissipating section includes:

a) a cooling-liquid container which is fixed to the back side of the LED-mounting base, and which has a closed space containing a cooling liquid; and

b) heat-dissipating fins provided around the cooling-liquid container.

### Effect of the Invention

According to the present invention, the heat generated by the LED element is conducted to the heat-dissipating fins through the LED-mounting base and the cooling liquid which is in contact with the back side of the LED-mounting base, whereby the heat is efficiently dissipated. The heat from the LED element will be more efficiently conducted to the heat-dissipating fins when convection of the cooling liquid is produced in the cooling-liquid container.

In the LED lighting apparatus according to the present invention, the power circuit, control circuit and other electric circuits for driving the LED element in the LED lighting apparatus can be contained in the cooling-liquid container (in the form of being immersed in the cooling liquid). Therefore, the LED lighting apparatus according to the present invention efficiently use the installation space. Furthermore, the direct immersion of the electric circuits in the cooling liquid has the natural effect of efficiently removing heat emitted from the entirety of electric circuits. Therefore, it is unnecessary to use a radiator and a structure connecting thereto, which are normally required for a power circuit or electronic circuit. This contributes to the minimization of the size of the electric circuit. It also ensures a stable operation of the LED lighting apparatus. The electric circuit for driving the LED element may be either entirely or only partially contained in the cooling-liquid container.

It is preferable to leave a small space in the cooling-liquid container rather than completely fill the container with the cooling liquid. This space alleviates an increase in the pressure in the cooling-liquid container due to an expansion of the liquid which occurs when the temperature of the cooling liquid increases. In this respect, the pressure in the space that is not filled with the cooling liquid in the cooling-liquid container should preferably be a negative pressure (and as close to vacuum as possible) at room temperature.

To promote the heat transfer from the LED-mounting base to the cooling liquid, it is desirable to provide a coarse structure on the back side of the LED-mounting base to increase the contact area between the LED-mounting base and the cooling liquid. The coarse structure may have any shape; for example, it may be shaped like concentric rings or a number of standing pins. To further promote the heat transfer between the LED-mounting base and the cooling liquid, it is desirable to provide a heat pipe protruding from the back side of the LED-mounting base in place of or in addition to the aforementioned coarse structure.

Just in case the previously described heat-dissipating means does not sufficiently work (e.g. the aforementioned heat-transfer effect by the convection of the cooling liquid will diminish when the LED lighting apparatus is positioned so that the LED-mounting base is higher than the cooling liquid in the direction of the gravitational force), the LED lighting apparatus according to the present invention may include a sensor for detecting an increase in the temperature of the LED element and a limiter for limiting the power supplied to the LED element according to the temperature of the LED element detected by the sensor. The limitation of the power may be implemented by controlling an electric current supplied to the LED element or blinking the LED element. The sensor may be provided in or on the LED element itself or placed on or near the LED-mounting base.

### BRIEF DESCRIPTION OF THE DRAWINGS

FIG. 1A is a vertical-sectional view of a suspended LED lighting apparatus as one embodiment of the present invention, and FIG. 1B is a cross-sectional view at line X-X′ in FIG. 1A.

FIG. 2 is a cross-sectional view showing another example of the heat-dissipation and electrical-equipment section.

FIG. 3 is a cross-sectional view showing still another example of the heat-dissipation and electrical-equipment section.

FIG. 4 is a vertical-sectional view of the light-emitting part of the same embodiment.

FIG. 5 is a perspective view showing one example of the projecting portion of the LED-mounting substrate.

FIG. 6 is a perspective view showing another example of the projecting portion of the LED-mounting substrate.

FIG. 7 is a perspective view showing still another example of the projecting portion of the LED-mounting substrate.

FIG. 8 is a vertical-sectional view of a recessed LED lighting apparatus as another embodiment of the present invention.

FIGS. 9A-9D are (A) vertical-sectional view, (B) plan view, (C) front view and (D) side view of a street-light type LED lighting apparatus as still another embodiment of the present invention.

FIG. 10 is a vertical-sectional view showing another example of the configuration of the aforementioned suspended LED lighting apparatus.

### BEST MODE FOR CARRYING OUT THE INVENTION

Embodiments of the present invention are hereinafter described by means of the drawings.

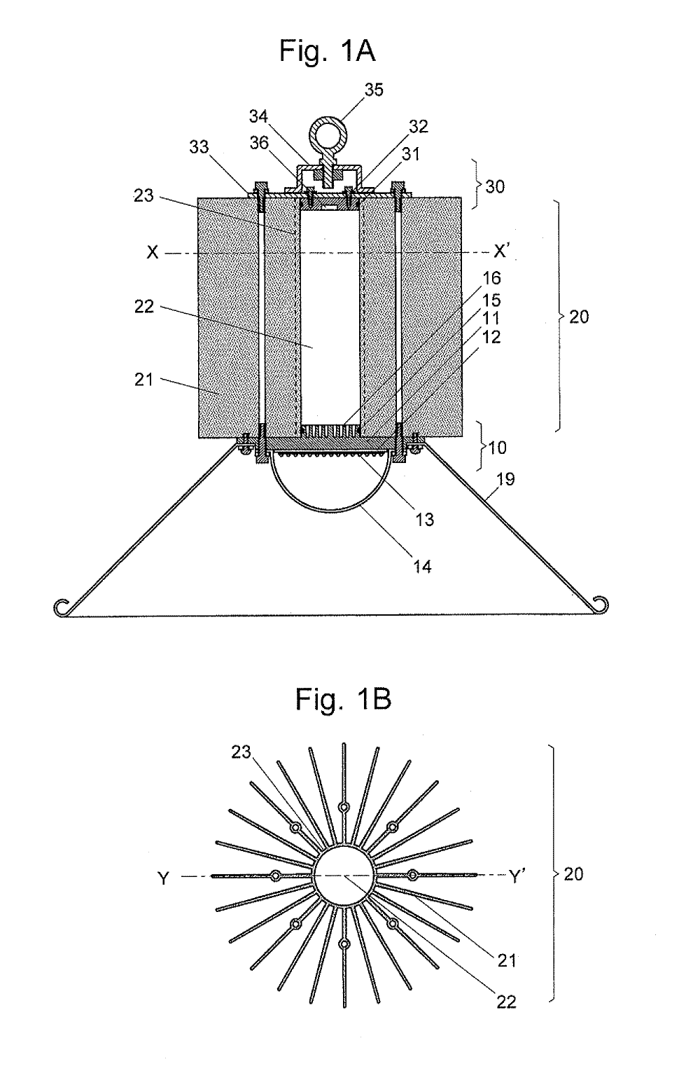

FIGS. 1A and 1B show a suspended LED lighting apparatus as one representative embodiment of the present invention, where FIG. 1A is a vertical-sectional view of this lighting apparatus (showing the section at line Y-Y′ in FIG. 1B), and FIG. 1B is a sectional view at line X-X′ in FIG. 1A.

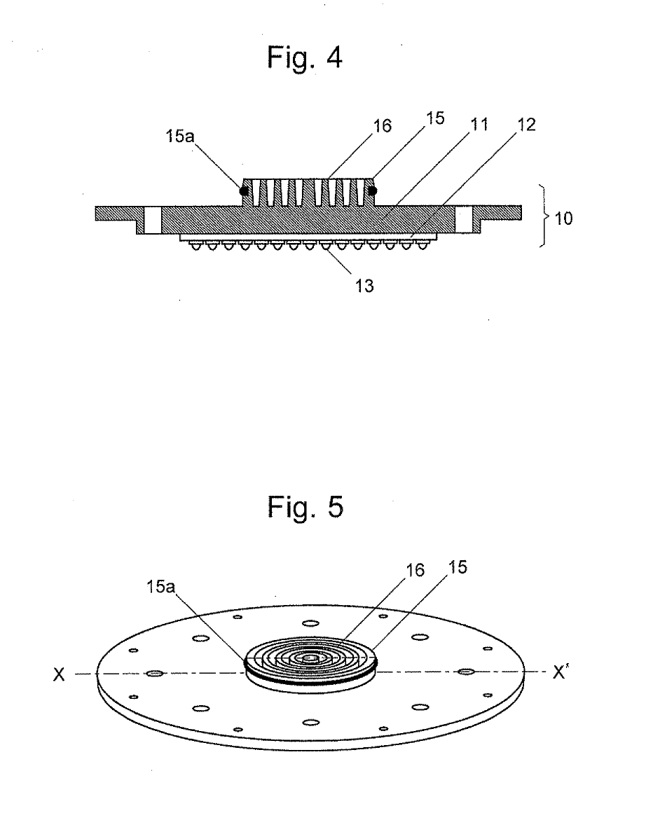

The present LED lighting apparatus has a light-emitting part 10 at its center. As shown in FIG. 4, the light-emitting part 10 is composed of an LED-mounting base 11 made of a highly heat-conductive material, such as aluminum or copper, an LED-mounting substrate 12 thermally fixed to the LED-mounting base 11, and a large number of LED elements 13 mounted on the LED-mounting substrate 13. Furthermore, as shown in FIG. 1A, a barrier 14 made of a transparent or semi-transparent resin or glass should preferably be attached to the LED-mounting base 11 to entirely cover the LED-mounting substrate 12 so as to protect the LED elements 13 from rain, dust, insects or the like. The side on which the LED elements 13 are located with respect to the LED-mounting base 11 is hereinafter called the “front” side, and the opposite side is called the “back” side.

The LED-mounting base 11 has a reflector 19 attached to its circumference, which is shaped like a circular truncated cone spreading frontward and reflects light generated from the light-emitting part 10 toward required directions. Using a highly heat-conductive material, such as aluminum, as the material of the reflector 19 enables this reflector 19 to serve as a radiator for dissipating frontward the heat generated from the LED elements 13.

Located on the back side of the light-emitting part 10 (the upper side in FIG. 1A) is a heat-dissipation and electrical-equipment section 20 made of a piece of extruded aluminum or similar material. As shown in FIG. 1B, the heat-dissipation and electrical-equipment section 20 consists of a central core 23 (cooling-liquid container) in the form of a thin cylinder and a number of radial heat-dissipating fins 21 extending from the cylinder to increase the surface area so that heat can be efficiently dissipated by radiation, transfer to the air, and convection of the air. The internal space of the core 23 serves as an electronic-circuit housing section 22 containing an electronic circuit for converting an alternating current of a commercial power source into a direct current for energizing the LED elements 13. The electronic-circuit housing section 22 has its lower end hermetically closed with the LED-mounting base 11 and its upper end hermetically closed with an upper sealing part 30, thus forming a closed space. Contained in this space is a chemically stable, non-flammable cooling liquid having a high level of insulating performance, such as silicon oil.

It is also possible to use, as this cooling liquid, a low-boiling liquid having a boiling point of approximately 50 to 80 degrees Celsius. In this case, the liquid can repeat the heat-transfer cycle of turning into gas by absorbing heat from the LED elements and then returning to liquid by giving heat to the heat-dissipating fins 21, whereby the efficiency of removing heat from the LED elements 13 is further improved.

In the present embodiment, the upper sealing part 30 is composed of a sealing body 32 made of a resin or similar material, with a seal 31 (e.g. O-ring) fitted on its circumference, and a metal member 33 holding the sealing body 32 and being used for fastening the upper sealing part 30 to the heat-dissipation and electrical-equipment section 20. The metal member 33 has a welded or screwed metal fitting 34, to which a suspending part 35 is fixed with a screw and nut. With this suspending part 35, the present LED lighting apparatus can be suspended from the ceiling of a building or other locations.

In putting a cooling liquid into the electronic-circuit housing section 22, if the space is completely filled with the liquid, a large pressure occurs due to the difference in the coefficient of thermal expansion between the cooling liquid and the metal or other materials forming the space, which makes leakage of the cooling liquid or other problems more likely to occur. Accordingly, it is preferable to leave a small volume of space. In the present embodiment, as shown in FIG. 1A, the recess 36 formed on the lower side of the sealing body 32 provides such a space. If this space is filled with air of ordinary pressure, the pressure will change as the air expands due to the heat. Accordingly, the space should preferably be made to be at a negative pressure (i.e. lower than normal pressures) at room temperature (5 to 35 degrees Celsius) or at an approximately vacuum level.

Other than the aforementioned method in which the recess 36 is provided, the following method may be used to create the pressure-reduced space: A closed bag made of a soft plastic sheet, containing a small volume of air or the like, is initially put in the electronic-circuit housing section 22, after which the electronic-circuit housing section 22 is filled with the cooling liquid. Then, a small volume of cooling liquid is sucked from the electronic-circuit housing section 22, whereupon the closed bag swells, with its internal pressure being reduced. Therefore, even if the cooling liquid expands due to a temperature increase, the closed bag can absorb the expansion.

As shown in FIGS. 4-7, the LED-mounting base 11 has, on its back side (which is in contact with the cooling liquid), a projecting portion 15 shaped like a low table having an outer diameter slightly smaller than the inner diameter of the electronic-circuit housing section 22, with a seal member 15a (e.g. O-ring) fitted on its circumference. The seal member 15a hermetically closes the gap between the projecting portion 15 of the LED-mounting base 11 and the inner wall of the electronic-circuit housing section 22, whereby the lower end of the electronic-circuit housing section 22 is sealed.

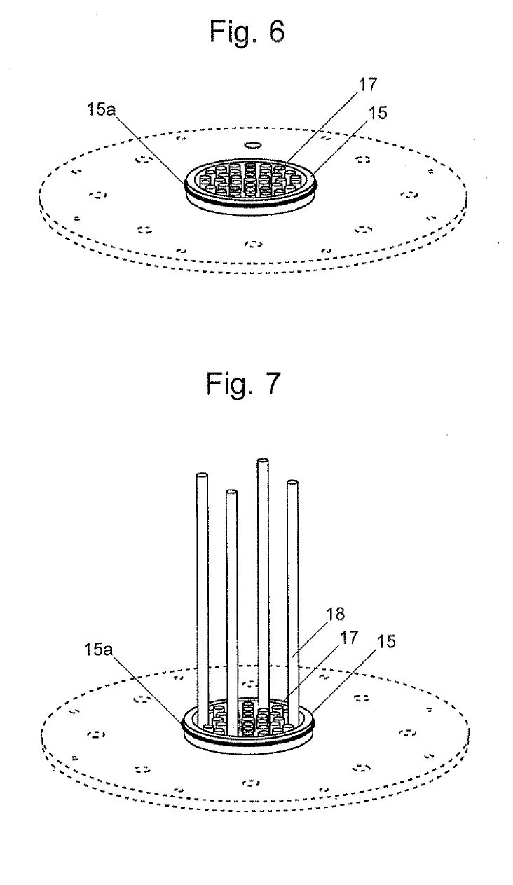

To increase the contact area between the projecting portion 15 of the LED-mounting base 11 and the cooling liquid, ring-shaped fins 16 as shown in FIG. 5 or pin-shaped projections 17 as shown in FIG. 6 are provided on the contact portion of the projecting portion 15 to efficiently transfer the heat from the LED elements 13 through the LED-mounting base 11 to the cooling liquid.

As a result, the heat generated by the LED elements 13 is efficiently transferred through the LED-mounting base 11 to the above-located cooling liquid. Heating the lower portion of the cooling liquid causes convection in the liquid, whereby the heat is quickly transferred upward, to be eventually dissipated into the air through the large-area heat-dissipating fins 21 located around and above. As already explained, a low-boiling liquid having a boiling point of approximately 50 to 80 degrees Celsius can be used as the cooling liquid to add a heat-transfer effect by the gasification-liquefaction cycle of the liquid and thereby further improves the heat-dissipating efficiency.

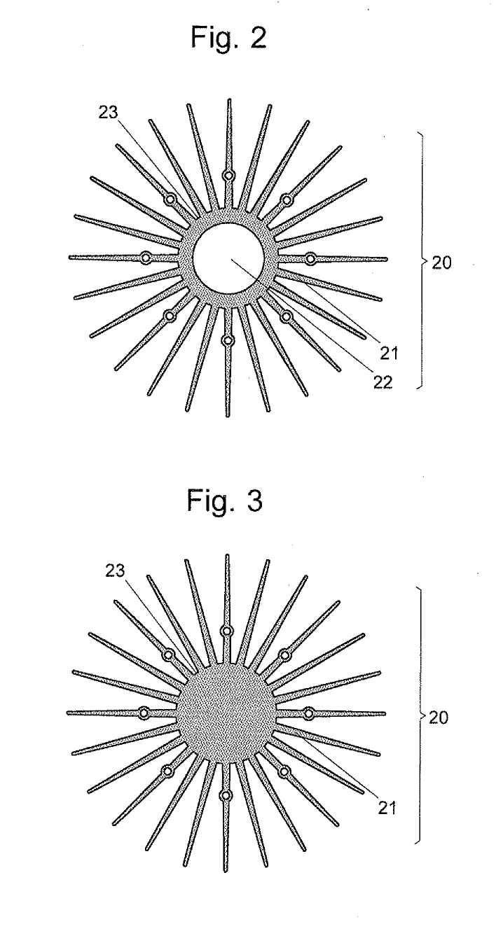

In this case, the core 23 of the heat-dissipation and electrical-equipment section 20 may be made to be thicker, as shown in FIG. 2, to directly conduct heat from the LED-mounting base 11 to the heat-dissipation and electrical-equipment section 20 and further through the thick-walled core 23 to the heat-dissipating fins 21 located around and above. However, as compared to the heat transfer by the convection of the cooling liquid, the heat conduction in the solid has higher thermal resistances and easily leads to a large temperature difference between the upper and lower portions.

Although a further increase in the thickness of the core 23 (and particularly outward) can reduce this temperature difference, it also increases the weight and makes the device more expensive. Furthermore, the increased outer diameter of the core 23 requires the heat-dissipation and electrical-equipment section 20 to be even larger if the surface area of the heat-dissipating fins 21 per unit length needs to be maintained.

Using a solid core 23 as shown in FIG. 3 improves the cooling capability without increasing the device size. However, it also increases the weight and cost of the device. Furthermore, this structure requires electric circuits to be mounted outside, which additionally increases the weight, size and cost.

In FIGS. 1A and 1B, the core 23 of the heat-dissipation and electrical-equipment section 20 has an opening, and a closed space is formed within the core 23 by closing this opening with the LED-mounting base 11. However, this is not the only possible structure. For example, it is possible to use a previously closed core 23, with a cooling liquid contained therein, and fix the LED-mounting base 11 to the outer wall surface of the core 23. In this case, the coarse structure for increasing the area of contact with the cooling liquid, such as the ring-shaped fins 16 or pin-shaped projections 17, should be provided on the back side of the surface of the core 23 to which the LED-mounting base 11 is fixed (i.e. on the inner wall surface of the core 23).

The previous descriptions dealt with the case of setting the lighting apparatus as shown in FIG. 1A. If the apparatus is set upside down, the heat transfer performance will significantly deteriorate because the contact area between the projecting portion 15 and the cooling liquid decreases (if the electronic-circuit housing section 22 is not completely filled with the cooling liquid) and no convection of the cooling liquid occurs since the heating of the liquid occurs in the upper portion (even if the housing section 22 is completely filled).

The first method for solving this problem is to decrease the electric current supplied to the LED elements 13 when a temperature increase due to the difference in the setting direction is detected by a sensor placed in the vicinity of the LED elements 13, on the LED-mounting base 11 or at a position near the LED elements in the electronic circuit located in the electronic-circuit housing section 22. By this method, the temperature of the LED elements 13 can be maintained within a predetermined range

The second method is to reduce the substantial amount of power by blinking the LED elements 13 at short intervals of time, instead of decreasing the current supplied to the LED elements 13. This method has the additional effect of informing the user of an abnormal increase in the temperature by the blinking signal. It is also possible to vary the blinking interval (rhythm) according to the level of the temperature.

The third method is to use, as shown in FIG. 7, one or more heat pipes 18 to transfer heat from the LED-mounting base 11 to the cooling liquid. Using heat pipes 18 having a sufficient length produces a heat-transfer effect that can compensate for a decrease in the heat-transfer effect which occurs when the convection of the cooling liquid is impeded due to a change in the setting direction of the LED lighting apparatus. The temperature difference between the cooler heat-dissipating fins 21 and the hotter heat pipes produces convection of the liquid, whereby a sufficient cooling effect can be obtained.

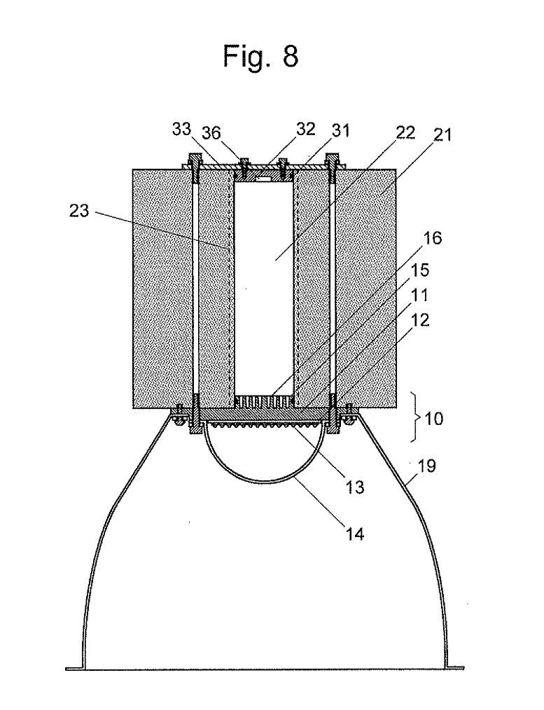

The previously described apparatus was an example of the suspended LED lighting apparatus. This apparatus can be changed to different types of LED lighting apparatuses, such as a down-light used in a ceiling, by changing the shape of the reflector 19 as shown in FIG. 8 or using different kinds of fittings.

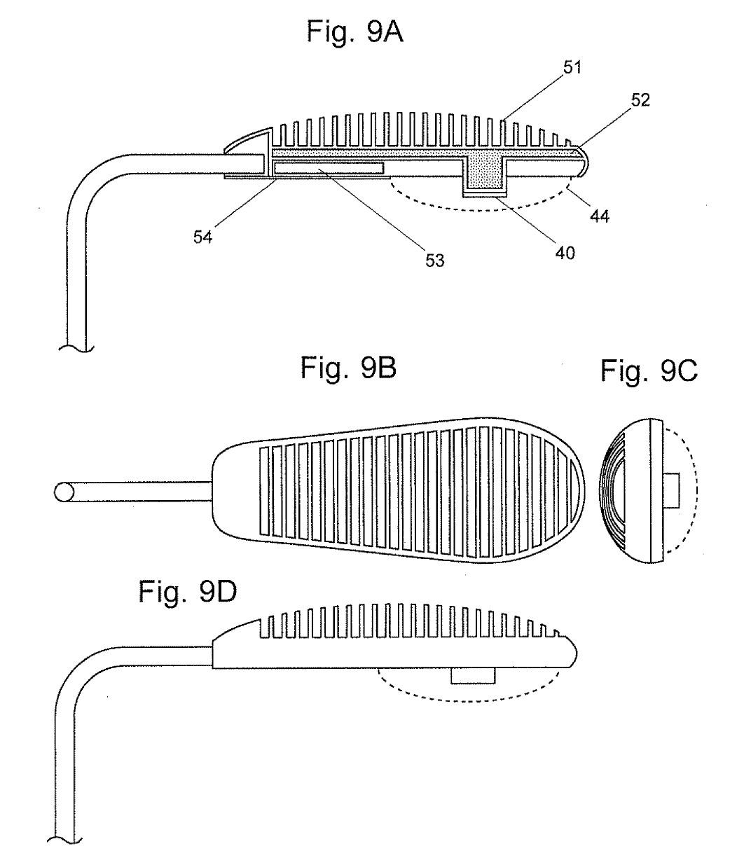

The technique of efficiently transferring and dissipating heat by using a liquid for the heat transfer can also be applied to such types of lighting devices that must be excellent in design and therefore disallow the LED-mounting section and the heat-dissipating section to be closely arranged, as in the case of street lights. FIGS. 9A-9D show such an example. As shown in FIG. 9A, this street-light type LED lighting apparatus has a cooling-liquid container 52 fixed to the back side (upper side in FIG. 9A) of a light-emitting part 40 for radiating light downward. Heat-dissipating fins 51 are provided in the upper portion of the cooling-liquid container 52. In the present example, the electronic circuit (electronic-circuit mounting part 53) is located not inside but outside the cooling-liquid container 52. FIGS. 9B-9D are respectively a plan view, front view and side view of the present embodiment. Numeral 44 in FIG. 9A denotes a transparent barrier, and numeral 54 denotes a lower cover.

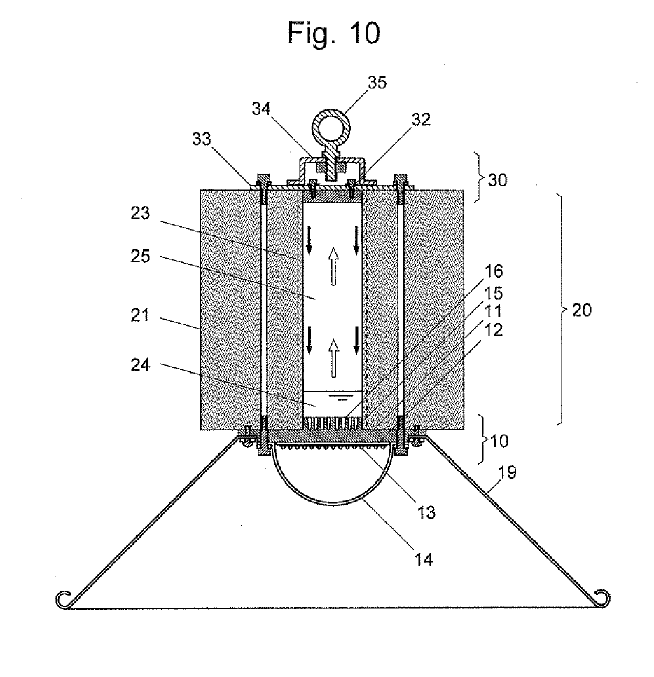

As already stated, the LED lighting apparatus according to the present invention can be designed to transfer heat by a gasification-liquefaction cycle of the cooling liquid. One example of this design is shown in FIG. 10. It should be noted that the components identical or corresponding to the components in FIG. 1 will be denoted by the same numerals, and the descriptions of such components will be appropriately omitted.

In the LED lighting apparatus shown in FIG. 10, a small volume of cooling liquid 24 is stored in the internal space of the core (cooling-liquid container) 23. (The volume does not exceed one half of the capacity of the internal space 25 at room temperature.) The internal space 25 is maintained at an appropriate degree of vacuum so that the boiling point of the cooling liquid 24 will not exceed the upper limit of the temperature achieved by the LED-mounting base 11 when the LED elements 13 are energized at room temperature. (The boiling point should be lower than 100 degrees Celsius, and preferably within a range from 50 to 80 degrees Celsius.)

In this apparatus, the heat generated by the energized LED elements 13 is transferred through the LED-mounting base 11 to the cooling liquid 24. This heat causes the cooling liquid 24 to boil, turning the cooling liquid 24 into vapors, which ascend through the internal space 25, as indicated by the white arrows in FIG. 10. During this process, the vapors give heat to the heat-dissipating fins 21, as a result of which the cooling liquid 24 turns to liquid and returns to the lower portion of the internal space 25, as indicated by the black arrows in FIG. 10. That is to say, this apparatus makes the entire core 23 function as a heat pipe, whereby the previously described heat-transfer cycle is repeated to further improve the efficiency of removing the heat from the LED elements 13.

The present apparatus also allows the electric circuits for driving the LED elements 13 to be partially or entirely contained in the inner space 25 of the core 23. Although there is no specific limitation on the kind of cooling liquid 24, it is preferable to use a non-flammable liquid with high insulation resistance, taking into account the possibility that an electric circuit is contained in the internal space 25. One preferable example of such a liquid is Fluorinert™, a product of fluorinated inert liquid manufactured by Sumitomo 3M Limited.

In the previously described system in which the heat transfer is achieved by the gasification-liquefaction cycle of the cooling liquid, a relatively high degree of vacuum must be maintained in the internal space 25 of the core 23 to lower the boiling point of the cooling liquid. For this purpose, rather than using the seal members 15a and 31 shown in FIGS. 1A and 4, it is preferable to ensure tight-sealing of the internal space 25 by press-fitting, adhering or welding the projecting portion 15 of the LED-mounting base 11 and the sealing body 32 into or to the ends of the cylindrical core 23, respectively. By this structure, a high degree of vacuum can be maintained over a long period of time.

### EXPLANATION OF NUMERALS

10 . . . Light-Emitting Part
11 . . . LED-Mounting Base
12 . . . LED-Mounting Substrate
13 . . . LED Element
14 . . . Barrier
15 . . . Projecting Portion
15a . . . Seal Member
16 . . . Fin
17 . . . Pin-Shaped Projection
18 . . . Heat Pipe
19 . . . Reflector
20 . . . Heat-Dissipation and Electrical-Equipment Section
21 . . . Heat-Dissipating Fin
22 . . . Electronic-Circuit Housing Section
23 . . . Core
24 . . . Cooling Liquid
25 . . . Internal Space
30 . . . Upper Sealing Part
32 . . . Sealing Body
33 . . . Metal Member
34 . . . Metal Fitting
35 . . . Suspending Part
36 . . . Recess for Absorbing Expansion of Cooling Liquid
40 . . . Light-Emitting Part
41 . . . Electronic-Circuit Mounting Part
44 . . . Barrier
51 . . . Heat-Dissipating Fin
52 . . . Cooling-Liquid Container
53 . . . Electronic-Circuit Mounting Part
54 . . . Lower Cover

1. An LED lighting apparatus including an LED-mounting base having an LED element mounted on a surface thereof and a heat-dissipating section, the heat-dissipating section comprising:
a) a cooling-liquid container which is fixed to a back side of the LED-mounting base, and which has a closed space containing a cooling liquid; and
b) heat-dissipating fins provided on an outer surface of the cooling-liquid container.

2. The LED lighting apparatus according to claim 1, wherein the closed space of the cooling-liquid container is incompletely filled with the cooling liquid.

3. The LED lighting apparatus according to claim 2, wherein a pressure in the closed space of the cooling-liquid container is a negative pressure at room temperature.

4. The LED lighting apparatus according to claim 2, wherein a boiling point of the cooling liquid in a state of being contained in the cooling-liquid container is lower than an upper limit of a temperature achieved by the LED-mounting base when the LED element is energized.

5. The LED lighting apparatus according to claim 1, wherein a coarse structure for increasing a contact area between the LED-mounting base and the cooling liquid is provided on an inside of the cooling-liquid container at a location where the cooling-liquid container is fixed to the LED-mounting base.

6. The LED lighting apparatus according to claim 1, wherein a heat pipe protruding into the cooling liquid is provided on an inside of the cooling-liquid container at a location where the cooling-liquid container is fixed to the LED-mounting base.

7. The LED lighting apparatus according to claim 1, further comprising:
a temperature sensor provided on the LED element, on the LED-mounting base, or in a vicinity of the LED element or the LED-mounting base; and
a current controller for controlling, based on a detection value of the temperature sensor, an electric current supplied to the LED element.

8. The LED lighting apparatus according to one claim 1, further comprising:
a temperature sensor provided on the LED element, on the LED-mounting base, or in a vicinity of the LED element or the LED-mounting base; and
a blink controller for blinking the LED element based on a detection value of the temperature sensor.

9. The LED lighting apparatus according to claim 1, wherein at least a portion of an electric circuit for driving the LED element is housed in the cooling-liquid container.
